(19) United States
(12) Patent Application Publication
(10) Pub. No.: US 2022/0083569 A1
(43) Pub. Date: Mar. 17, 2022

(54) INFORMATION PROCESSING APPARATUS, INFORMATION PROCESSING METHOD, NON-TRANSITORY COMPUTER READABLE MEDIUM

(71) Applicant: KABUSHIKI KAISHA TOSHIBA, Tokyo (JP)

(72) Inventors: Akihiro YAMAGUCHI, Kita (JP); Ken UENO, Tachikawa (JP)

(73) Assignee: KABUSHIKI KAISHA TOSHIBA, Tokyo (JP)

(21) Appl. No.: 17/187,398

(22) Filed: Feb. 26, 2021

(30) Foreign Application Priority Data
Sep. 15, 2020 (JP) 2020-154782

(51) Int. Cl. G06F 16/28

(52) U.S. Cl. CPC G06F 16/285

(57) ABSTRACT

An information processing apparatus as one embodiment of the present invention includes a feature value calculator, a classifier, an updater, and a detector. The feature value calculator calculates feature values of waveforms of a plurality of time-series data for each of a plurality of reference waveform patterns. The classifier acquires a classification result by inputting the feature values to a classification device. The updater updates a shape of each of the reference waveform patterns, and a plurality of parameters of the classification device. The detector detects reference waveform patterns having a relationship, from the plurality of reference waveform patterns, based on the parameters of the classification device.

### CROSS-REFERENCE TO RELATED APPLICATION (S)

This application is based upon and claims the benefit of priority from Japanese Patent Application No. 2020-154782, filed Sep. 15, 2020; the entire contents of which are incorporated herein by reference.

### FIELD

An embodiment relates to an information processing apparatus, an information processing method, a non-transitory computer readable medium.

### BACKGROUND

When classifying analysis results based on time series data into a plurality of classes (classification items), it is preferable to clarify the basis of classification in addition to high classification performance. In recent years, a shapelet learning method, which is a technique for classifying time series data into classes and capable of clarifying the basis of classification, has been proposed and is attracting attention in fields of data mining, machine learning and the like. In the shapelet learning method, not only a classification device but also a waveform pattern that is the basis of classification is learned. The waveform pattern is also referred to as a shapelet.

On the other hand, many sensors are used to detect abnormalities in equipment in social infrastructure, manufacturing factories, and the like, and normality and abnormalities are estimated based on the waveforms of time-series data measured by these sensors. At that time, estimation may be made by using the temporal relationship of a plurality of time-series data by different sensors. For example, a circuit breaker in a substation can be determined to be abnormal or not, based on the temporal relationship between two kinds of the waveforms of data of the stroke waveform and the command current. For example, when both the temperature and pressure of a fuel cell rise at the same time, it may be considered that an abnormality has occurred in the fuel cell. As described above, the presence or absence of a temporal relationship such as whether the shapelet included in each of the plurality of time-series data occurs at the same time may also be required when the classification is performed.

Therefore, it is conceivable that if it is possible to generate a classification device in which not only shapelets effective for classification but also simultaneous occurrence of shapelets, in other words, the synchronism of shapelets may be taken into consideration, it will help engineers to analyze, and further clarify the basis of classification. However, in the shapelet learning method, the temporal relationship between the variables of the respective shapelets cannot be taken into consideration, and the relationship cannot also be extracted.

### BRIEF DESCRIPTION OF THE DRAWINGS

FIG. 1 is a block diagram illustrating an example of an information processing apparatus according to one embodiment of the present invention;

FIG. 2 is a diagram explaining shapelets;

FIG. 3 is a diagram explaining setting of offsets;

FIG. 4 is a diagram illustrating a first example of output;

FIG. 5 is a diagram illustrating a second example of output;

FIG. 6 is a diagram illustrating a third example of output;

FIG. 7 is a schematic flowchart of learning processing;

FIG. 8 is a schematic flowchart of classification processing;

FIGS. 9A and 9B are diagrams illustrating input and output in the case of narrowing down the number of shapelets;

FIGS. 10A and 10B are diagrams illustrating examples of fitting shapes of shapelets to specified classes; and

FIG. 11 is a block diagram illustrating an example of a hardware configuration in one embodiment of the present invention.

### DETAILED DESCRIPTION

One embodiment of the present invention provides a device or the like configured to generate a classification device in which a relationship of shapelets is also taken into consideration.

An information processing apparatus as one embodiment of the present invention includes a feature value calculator, a classifier, an updater, and a detector. The feature value calculator calculates feature values of waveforms of a plurality of time-series data for each of a plurality of reference waveform patterns. The classifier acquires a classification result by inputting the feature values to a classification device. The updater updates a shape of each of the reference waveform patterns, and a plurality of parameters of the classification device. The detector detects reference waveform patterns having a relationship, from the plurality of reference waveform patterns, based on the parameters of the classification device.

An embodiment will be explained in detail below with reference to the accompanying drawings. The present invention is not limited to the embodiment.

### One embodiment of Present Invention

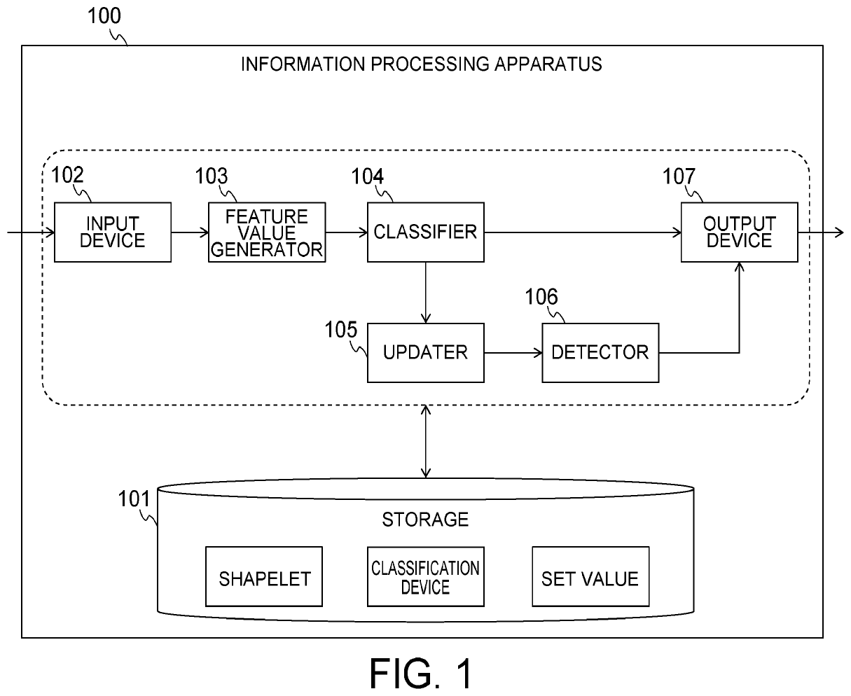

FIG. 1 is a block diagram illustrating an example of an information processing apparatus according to one embodiment of the present invention. An information processing apparatus 100 relevant to the present embodiment includes a storage 101, an input device 102, a feature value generator 103, a classifier 104, an updater 105, a detector 106, and an output device 107.

The information processing apparatus 100 generates a classification device. The classification device selects any one of a plurality of classes (classification items) based on time-series data concerning a plurality of items in the same period. For example, based on a plurality of time-series data indicating measurement values for one day of each of a plurality of sensors installed in monitor equipment, the classification device selects a class concerning a state of the equipment.

Note that generation of the classification device means bringing values of parameters of the classification device closer to appropriate values by repeatedly performing learning using a plurality of time-series data. Therefore, the information processing apparatus 100 can also be said to be a learning device.

Note that an item indicated by the time-series data, that is, what the time-series data indicates is not specially limited. The item does not have to be what is measured by a sensor, and may be, for example, data of indicators such as stock prices and corporate performance. Further, a plurality of items are respectively different, but items are regarded as different items even if the items are the same items, if the items are distinguishable. For example, a temperature on a device top surface, a temperature on a device side surface, a temperature on a device undersurface and the like are regarded as different items, because they are different in places even though they are the same kind of measurement items called temperature. Further, a length of a period of time-series data may be properly set, for example, as one hour, one day or the like. Predetermined time points in a unit period are assumed to be equidistant, and may be the same or different in each of time-series data. For example, measurement data of 1 day measured by a first sensor every second, measurement data of 1 day measured by a second sensor every minute, and measurement data of 1 day measured by a third sensor every 5 minutes may be used as one set. Note that it is assumed that there is no loss in the time-series data.

Further, the number and contents of classes are not specially limited. For example, when classes indicate a state of a facility, the classes may indicate normal, abnormal, caution required, breakdown and the like. When the classes indicate future predictions such as weather, they may be, for example, fine, sunny, cloudy, rainy and the like.

Note that the item shown by the time-series data is also described as a variable, and a plurality of time-series data are also described as a multivariable time-series dataset.

Further, the information processing apparatus 100 also generates a shapelet (Shapelet) that is a partial waveform pattern shown as a basis of a classification result and effective for classification for each time-series data. That is to say, the classification result by the generated classification device is due to similarity of part of the waveform of time-series data with the generated shapelet. The shapelet can also be said to be a waveform to be a reference for classifying classes, and therefore is also described as a reference waveform pattern.

A shapelet is also brought closer to an appropriate shape by learning same way to the classification device. Note that in initial learning, it is assumed that there are a plurality of shapelets corresponding to respective time-series data, but the assumed shapelets are discarded during learning. Accordingly, there may be time-series data for which a corresponding shapelet is not generated as a result, and the number of shapelets corresponding to each of time-series data is not always uniform. For example, it is assumed that each of time-series data has 100 shapelets, and 100 shapelets in a form of default are prepared for each of time-series data. Learning about the shapes of the shapelets is started, shapelets on which learning is to be stopped are determined during learning, and the shapelets are discarded, that is, are assumed to be absent. The shapelets left by end of learning are the generated shapelets. The shapelets during learning can also be said as candidates of shapelets.

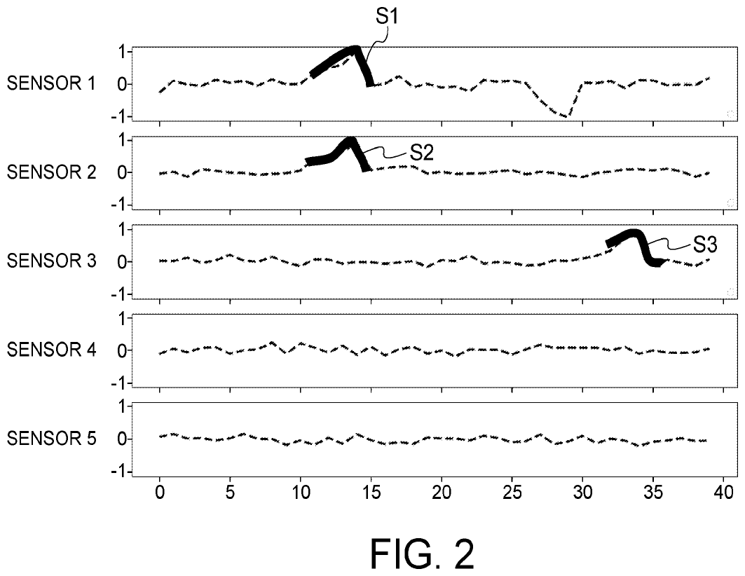

FIG. 2 is a diagram explaining shapelets. FIG. 2 illustrates waveforms of time-series data indicating measurement values by sensors 1 to 5, by dotted lines. FIG. 2 illustrates a shapelet S1 corresponding to time-series data of the sensor 1, a shapelet S2 corresponding to time-series data of the sensor 2, and a shapelet S3 corresponding to time-series data of the sensor 3. Note that in the time-series data of the sensors 4 and 5, corresponding shapelets are considered not to be generated. The class is determined as a result of the time-series data including parts similar to the shapelets as in FIG. 2.

Further, the information processing apparatus 100 also recognizes presence or absence of a temporal relationship of the generated shapelets. For example, the classification device selects a specific class, when a part similar to the shapelet 1 in the time-series data of the sensor 1, and a part similar to the shapelet S2 in the time-series data of the sensor 2 are present at the same time point, when the shapelets S1 and S2 in FIG. 2 are recognized to have a temporal relationship. In doing so, it is made possible to consider that an abnormality occurs when both a first measurement item and a second measurement item increase at the same time. Note that when a plurality of similar parts are not included at the same time, but included in a certain time width, it is made conceivable that the plurality of similar parts have a temporal relationship.

In the present embodiment, in order to detect shapelets having a temporal relationship, a plurality of shapelets are managed on a group basis. In each group, the same number of shapelets as the number of time-series data are included, and each of the shapelets has a one-to-one correspondence with the time-series data. For example, as an example in FIG. 2, when it is assumed that there are 5 time-series data, and 100 shapelets are present in each of the time-series data, 100 groups are created, and each of the groups includes 5 shapelets corresponding to the respective time-series data. As learning progresses, some shapelets are discarded, and the shapelets included in the respective groups decrease, as described above. The shapelets that belong to the same groups at a time of end of learning are considered to have a temporal relationship.

Symbols concerning the time-series data and shapelets, which are used in the present explanation, will be described. In the present embodiment, a plurality of time-series data in the same period are used as one set as the time-series data of the sensors 1 to 5 illustrated in FIG. 2. The number of time-series data per one set, in other words, the number of variables is assumed to be set as “V”. In the example in FIG. 2, the time-series data relating to the sensors 1 to 5 are present, and therefore V=5. Further, the number of sets used in learning is assumed to be set as “I”. For example, when the time-series data relating to the sensors 1 to 5 for each day are used for learning for about 3 days, the number “I” of sets is three. A length of each of the time-series data, that is, a length of a unit period is expressed by a symbol “Q”. A multivariable time-series dataset in a total number of “I” is expressed as “T”. The multivariable time-series dataset “T” is a tensor of I×V×Q.

In the present explanation, for convenience, lengths of the respective time-series data are assumed to be the same, and lengths of the respective shapelets are also assumed to be the same. Each of the shapelets is assumed to be made of “L” plots (points). The number of groups used to recognize the temporal relationship of the shapelets described above is expressed by a symbol “K”, and a shape of the shapelet is expressed by a symbol “S”. The shape “S” of the shapelet is a tensor of the number of shapelets×the length “L” of the shapelet, and can also be said as a tensor of the number “K” of groups×the number “V” of variables×the length “L” of the shapelet.

Parameters of the classification device are assumed to be expressed by using a weight vector (matrix vector) “W”. A bias term is omitted for simplification. The weight vector “W” becomes a sparse vector (sparse matrix) at a time of end of learning, as described later. The weight vector “W” is expressed by a vector of a dimension of a product of the number “K” of groups and the number “V” of time-series data (K×V). The product is the same as the number of shapelets, and each element of the weight vector “W” corresponds to one shapelet.

A shapelet with the corresponding element of the weight vector “W” being 0 does not affect classification of the classification device. In other words, the shapelet with the corresponding element of the weight vector “W” being 0 is ignored when the classification device calculates a classification result. Consequently, update of the shapelet with the corresponding element of the weight vector “W” being 0 may be stopped.

An internal configuration of the information processing apparatus 100 will be described. Note that components illustrated in FIG. 1 are for performing the above described processing, and other components are omitted. The respective components may be subdivided, or aggregated. For example, the storage 101 may be divided according to files and the like to be stored. The components other than the storage 101 may be regarded as an arithmetic operator. A processing result of each of the components may be sent to a component where a next process is performed, or may be stored in the storage 101, and the component where the next process is performed may access the storage 101 and acquire the processing result.

The storage 101 stores data used in processing of the information processing apparatus 100. For example, a classifying device and shapelets during learning or after end of learning are stored. Further, set values such as the number of shapelets assumed at beginning of learning, and lengths of the shapelets are stored. For example, the storage 101 may store a default value of the number “K” of shapelets included in a group being 100, a default value of the lengths “L” of the shapelets being Q×0.1, and the like. Processing results of the respective components of the information processing apparatus 100 and the like may be stored.

The input device 102 acquires data from outside. For example, the input device 102 acquires a time-series dataset for learning. The time-series dataset for learning is given a correct class (class level), and is compared with a classification result of the classification device.

Further, the input device 102 may receive input of a set value used in processing. For example, when the number of shapelets to be generated is limited, a set value of the number and the like is input, and may be used in place of the set value stored in the storage 101.

The feature value generator 103 calculates feature values of waveforms of a plurality of time-series data for each shapelet based on the waveforms of the plurality of time-series data, and a plurality of shapelets. For example, a Euclidean distance of a time-series data and a shapelet may be used as a feature value. In order to calculate the Euclidean distance of the time-series data and the shapelet, it is necessary to determine an offset (reference position) of the shapelet, and the offset is assumed to be common in the unit of group.

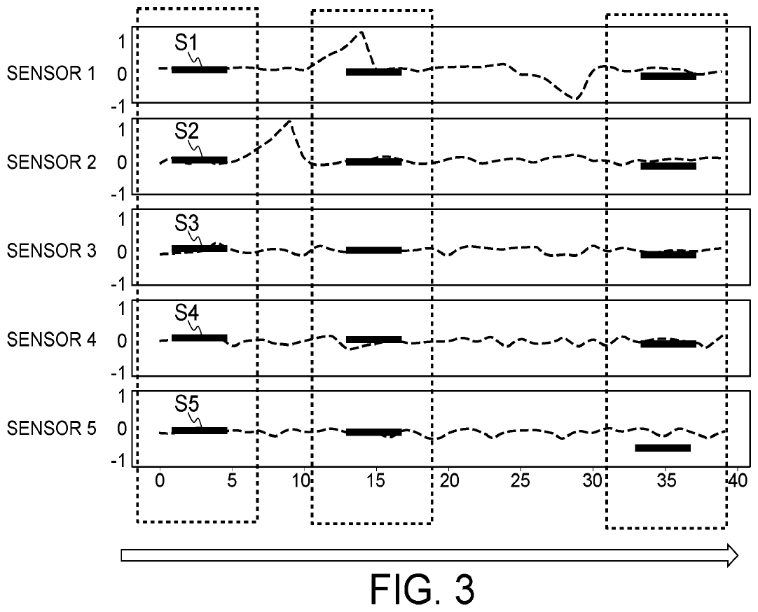

FIG. 3 is a diagram explaining setting of the offset. FIG. 3 illustrates shapelets S1 to S5 respectively corresponding to the respective time-series data, and belonging to the same group. In an example in FIG. 3, the shapelets S1 to S5 are in initial shapes before learning. A position of the offset common to the shapelets S1 to S5 is searched for and determined. As illustrated by frames of dotted lines and an arrow in FIG. 3, the position of each of the shapelets is shifted by a same amount, and a feature value in the group unit is calculated every time the position is shifted, and a spot at which the feature value finally becomes the smallest can be determined as the position of the offset. Note that the shapelets S4 and S5 are regarded as being absent during learning, and thereafter are also regarded as absent in calculation of the feature value. In other words, the time-series data of the sensor 4 is excluded from calculation of the feature value when or after the shapelet S4 is regarded as absent, and the time-series data of the sensor 5 is excluded from calculation of the feature value when or after the shapelet S5 is regarded as absent.

Note that in the above, the position of the offset is common in the time-series data in the same group, but at the time of search, the position of the offset in each of the time-series data is shifted within a predetermined time, and the spot at which the feature value becomes the smallest may be searched for. For example, the position of the offset of the shapelet S1 is assumed first, and the position of the offset of the shapelet S2 may be searched for within a predetermined range with the assumed position of the offset of S1 as a center. In other words, even if the position of the offset in each of the time-series data is deviated, it does not matter if the deviation of the position of the offset is within a predetermined time. Thereby, even when similar parts to the shapelets, of the respective time-series data are temporally back and forth, it can be determined that they have a temporal relationship.

Note that the feature value of the group may be shown as a feature vector of the same “K” dimension as the number of groups “K”. Alternatively, the feature value of a group may be integrated into one scalar value like an average of feature values of “V” shapelets belonging to the group, for example.

The classifier 104 acquires a classification result by inputting the calculated feature value into the classification device. A classification result is expressed by a numeric value such as a probability corresponding to a correct class. As the classification device, a same classification device as conventional one such as a support vector machine, and a neutral network model may be used.

The updater 105 updates values of a plurality of parameters of the classification device, and the shapes of the shapelets, based on the classification result. The update is performed so that the classification result approaches a correct answer. For example, update may be performed so that a value of a loss function including a numeric value such as a probability corresponding to the correct class as an argument becomes small. Alternatively, a gradient may be defined, and the parameters may be updated by using a gradient method.

Note that update of the parameters of the classification device is performed by updating a value of the weight vector “W”. As for update of the shapelet, for example, when there are two classes that are the first class and the second class, an average value of distances from the shapelets is calculated to a plurality of time-series data concerning the first class, and an average value of distances from the shapelets is calculated to a plurality of time-series data concerning the second class, and the shapelets are brought closer to waveforms with a smaller average value. Note that as described above, the shapelet with the corresponding element to the weight vector “W” being 0 does not have to be updated.

Note that update of the shapelet is preferably performed so that all shapelets included in the same group approach a waveform of time-series data concerning a specific class. For example, when the shapelets S1 and S2 having a temporal relationship are shaped so as to match parts of the time-series data concerning the first class, the shapelets S1 and S2 are superimposed on the time-series data concerning the first class, and thereby it can be understood that the shapelets match the time-series data at a glance.

Further, the updater 105 updates a value of the parameter that satisfies a condition to 0, out of the parameters of the classification device. In the case of a linear classification device, the updater 105 updates a value of an element that satisfies a condition to 0, among the elements of the weight vector “W”. For example, the updater 105 may determine the element of the weight vector “W” having a value of 0 based on absolute values of the values of the respective elements of the weight vector “W”. For example, a value of an element with a calculated value not being larger than a threshold may be made 0. Alternatively, the respective elements are ranked based on calculated values, and the value of the element with a rank not being larger than the threshold may be made 0. For example, the updater 105 may calculate an absolute value of a sum of each column of the weight vector “W”, and may determine a column of the weight vector “W” with a value of the element made 0, based on the calculated value. In other words, Σᵥ₌₁^{V}|W_{k,v}| is calculated for each of “K” columns, and the column of the weight vector “W” with the value of the element made 0 may be determined. For example, values of all elements existing in the column where the calculated values are not larger than the threshold may be made 0. Alternatively, the respective columns may be ranked based on the calculated values, and values of all the elements existing in the column where the rank does not exceed the threshold may be made 0. For example, sparse modeling such as sparse group lasso that is a method for estimating which parameter value becomes 0 may be used. In that case, a value of a regularization parameter is adjusted, and the element with a value made 0 is determined by applying a threshold function (Soft Thresholding Function) for determination. In this way, the condition may be properly set, and the element with the value made 0 is determined.

Note that in the above, the value of the parameter is assumed to be updated to 0, but the update means that the value of the parameter is made a specific value that is not affected by an unrequired shapelet. The specific value may be made a value other than 0, if the specific value is not affected by an unrequired shapelet.

Note that the updater 105 initializes the parameters of the classification device and the shapes “S” of the shapelets when learning is executed for the first time. In other words, the weight vector “W” is also initialized. In initialization, a value that is set, that is, an initial value may be properly set. For example, a segment of a length “L” is extracted from a time-series dataset, centroids (centers of gravity) of “K” clusters, that are obtained by clustering such as a k-means method, may be made the shapes of the initialized shapelets.

The detector 106 detects shapelets having a temporal relationship from a plurality of shapelets based on the parameters of the classification device. As described above, effective shapelets belonging to the same group have a temporary relationship, and the effective shapelets belonging to the same group are shapelets that exist in the same column of a determinant of the weight vector “W”, and correspond to the elements values of which are not 0. The value of the element of the weight vector “W” is made a specific value such as 0, by processing of the aforementioned updater 105, and therefore, it is possible to detect the shapelets having a temporary relationship based on the weight vector “W”.

Note that when there is only one element that does not have a specific value in the same column of the determinant of the weight vector “W”, the shapelet corresponding to the element does not have a temporal relationship with the other shapelets.

Further, the detector 106 may detect time-series data where a corresponding shapelet is absent. Absence of the corresponding shapelet means that the time-series data does not affect the classification result, and that the time-series data is not necessary for classification. Therefore, it is also possible to propose to detect and exclude the unrequired time-series data.

The output device 107 outputs processing results of the respective components. For example, the time-series data that are used, the respective generated shapelets, information indicating the temporal relationship of the detected shapelets and the like are output.

Further, the output format of the output device 107 is not specially limited, and may be a table or an image, for example. For example, the output device 107 may output a waveform based on the time-series data as an image.

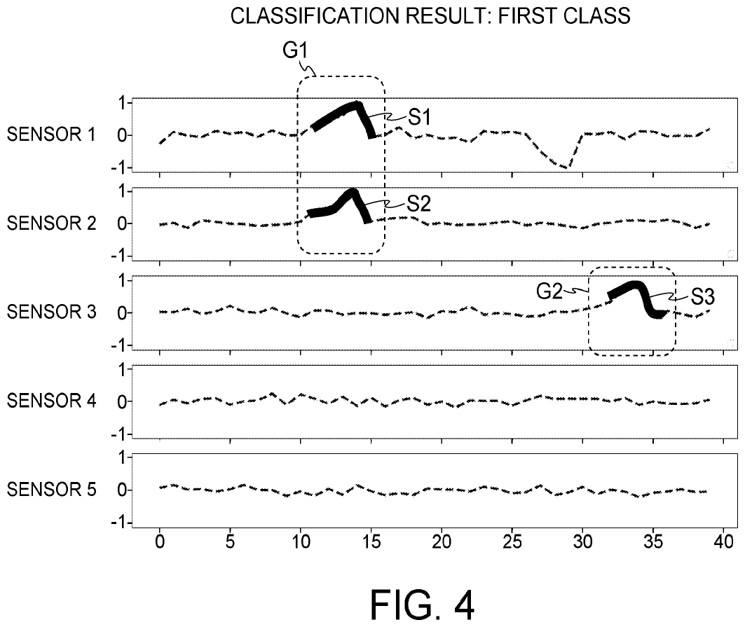

FIGS. 4 to 6 are diagrams illustrating first to third examples of output, respectively. FIG. 4 illustrates time-series data the classification result of which is a first class, generated shapelets S1 to S3, and frames G1 and G2 by dotted lines indicating information concerning a temporal relationship.

The shapelets S1 to S3 are assumed to be generated to match the time-series data the classification result of which is the first class. Accordingly, the shapelets S1 to S3 are illustrated by being superimposed on parts matching the shapelets S1 to S3, in the time-series data in FIG. 4. The output device 107 searches for and detects the parts of the time-series data, which match the generated shapelets same way to calculation of the feature value, and can display the shapelets corresponding to the detected parts by superimposing the corresponding shapelets on the detected parts.

A frame G1 indicates that the shapelets S1 and S2 encircled by the frame G1 have a temporal relationship. On the other hand, only the shapelet S3 is shown in the frame G2, and therefore it is indicated that the shapelet S3 does not have a shapelet having a temporal relationship with the shapelet S3. Note that in the example in FIG. 4, the positions of the frames G1 and G2 are deviated from each other, but even when the positions of the frames G1 and G2 are the same, the shapelet S3 does not have a temporal relationship with the shapelets S1 and S2 because the shapelet S3, and the shapelets S1 and S2 are encircled by the different frames.

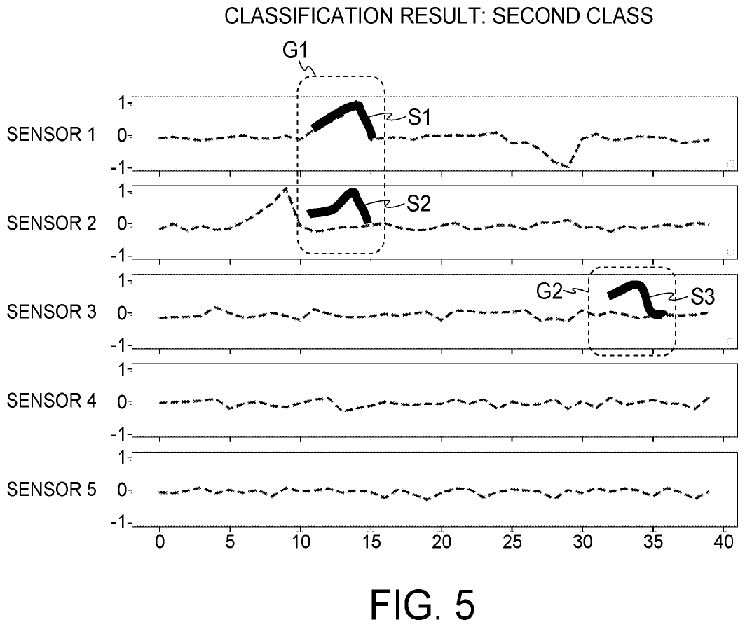

FIG. 5 illustrates time-series data a classification result of which is a second class, the generated shapelets S1 to S3, and the frames G1 and G2 of dotted lines indicating presence of temporal relationships. Since the shapelets S1 to S3 are generated so as to match the time-series data the classification result of which is the first class, there are few time-series data that have parts matching the shapelets. The time-series data of the sensor 1 in FIG. 5 has a part matching the shapelet S1, but at the same time point of the part, the shapelet S2 having a temporal relationship with the shapelet S1 does not match the time-series data of the sensor 2. In this case, it is highly likely to be determined that the class concerning the time-series data does not match the class concerning the shapelets.

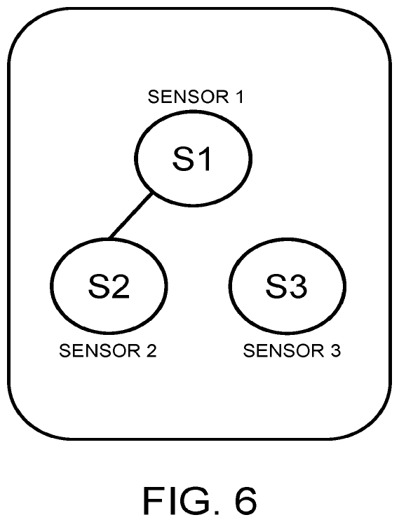

FIG. 6 illustrates three nodes respectively showing the shapelets S1 to S3, and a link indicating presence of a temporal relationship. Since the shapelets S1 and S2 have a temporal relationship, but do not have the temporal relationship with the shapelet S3 as described above, the link is created between the nodes indicating the shapelets S1 and S2, and the shapelet S3 does not have a link. Further, it may be illustrated to which time-series data the shapelets S1 to S3 correspond. An example in FIG. 6 also illustrates to which sensor time-series data the respective nodes correspond. Since the sensors 4 and 5 are not illustrated, it is also known that the sensors 4 and 5 do not contribute to classification. The output device 107 may display an image like this, and notify the temporal relationship.

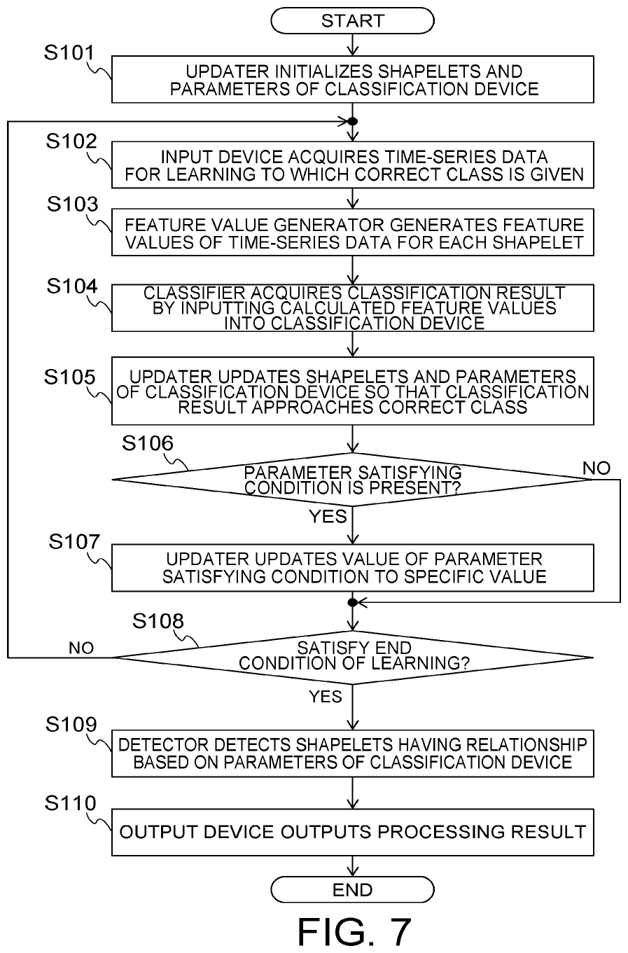

Next, a flow of the respective processes of the components will be described. FIG. 7 is a schematic flowchart of learning processing. The flowchart illustrates a flow concerning learning of the classification device and the like.

First, the updater 105 initializes shapelets and parameters of the classification device (S101). As for the respective initial values, those stored in the storage 101 may be used as describe above, or input of the initial values may be received via the input device 102. Thereafter, time-series data for learning to which a correct class is given are sent, and therefore the input device 102 acquires the time-series data for learning and the correct class (S102). Note that the time-series data for learning stored in the storage 101 may be acquired. The feature value generator 103 generates a feature value of time-series data for each shapelet (S103). The classifier 104 inputs the calculated feature value to the classification device and acquires a classification result (S104). The updater 105 updates the shapelets and parameters of the classification device so that the classification result approaches the correct class (S105). The shapelets are updated to match the waveforms of the time-series data of an estimated class.

Further, when a parameter that satisfies a condition of being close to a specific value is present and the like (YES in S106), the updater 105 updates a value of the parameter to the specific value (S107). When the parameter that satisfies the condition does not exist (NO in S106), the process in S107 is skipped. Processes from S102 to S107 are the flow of learning of one time.

When it is determined whether an end condition of learning is satisfied, and the end condition of learning is not satisfied (NO in S108), the flow returns to S102, and learning is performed again based on time-series data for next learning. When the end condition of learning is satisfied (YES in S108), learning of the classification device and the shapelets ends, and the detector 106 detects shapelets having a temporal relationship based on the parameter of the classification device (S109). The processing results of the generated shapelets, the detected shapelets having the temporal relationship and the like are output by the output device 107 (S110), and the flow ends.

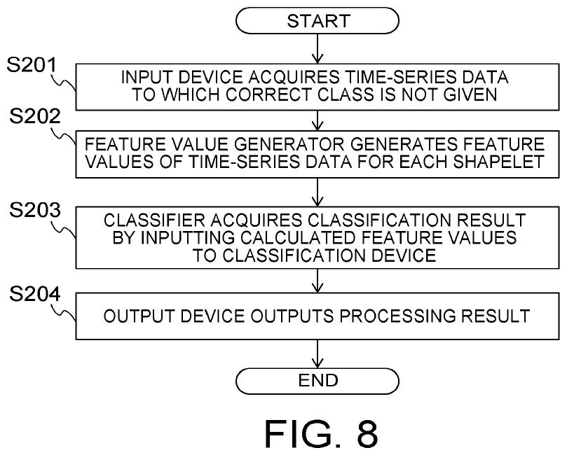

FIG. 8 is a schematic flowchart of classification processing. The flowchart is performed when time-series data that are not given a correct class are acquired when a test on the classification device is performed or the like, when learning of the classification device is completed.

The input device 102 acquires the time-series data that is not given a correct class (S201). The feature value generator 103 generates a feature value of time-series data for each shapelet (S202). The classifier 104 inputs the calculated feature value to the classification device and acquires a classification result (S203). The output device 107 outputs a processing result (S204), and the flow ends. In this way, update of the classification device and the shapelets, and detection of the shapelets having a temporal relationship are not performed in the flow.

Note that it is also possible to perform the above described classification processing by a different information processing apparatus from the information processing apparatus 1 that performs learning processing. For example, it is possible that learning processing is executed by the first information processing apparatus placed in a cloud, and classification processing is executed by a second information processing apparatus placed in the same facility as a facility of the sensor and the like that acquire the time-series data. In this case, the first information processing apparatus can also be said as a learning device, and the second information processing apparatus can also be said as a classification device.

As the above, the information processing apparatus 100 of the present embodiment can not only generate the shapelets that are a basis of classification, but also detect a temporal relationship of the generated shapelets when generating the classification device configured to classify classes based on the time-series data. Further, the time-series data that is not required in classification can be excluded. This enhances classification performance. Further, information on the shapelets and the time-series data having a temporal relationship is output, and thereby it is possible to help understanding of engineers who investigate a cause of abnormalities or the like.

Note that in the above, the updater 105 narrows down the number of shapelets by setting the value of the element of the weight vector “W” at 0, but the number of shapelets that is finally narrowed down may be specified. In other words, the number of shapelets may be narrowed down to the specified number. Alternatively, the number of time-series data having corresponding shapelets may be narrowed down. For example, the time-series data having the corresponding shapelets may be specified as a half of all the time-series data, or the number of shapelets corresponding to the respective time-series data may be determined to be limited to two at the maximum, or the number of all shapelets may be determined to be three times as large as the number of time-series data.

For example, in the aforementioned example, the time-series data by the sensors 1 to 5 are used, but it may be desired to know which of the sensors 1 to 5 is important for classification. Accordingly, the time-series data having corresponding shapelets may be decreased to the specified number by narrowing down the number of shapelets. In this way, the numbers of shapelets and time-series data may also be dealt as the conditions for narrowing down them. Thereby, the number of time-series data used in classification can be reduced. It is also possible to select a sensor or the like that is important for monitor or the like.

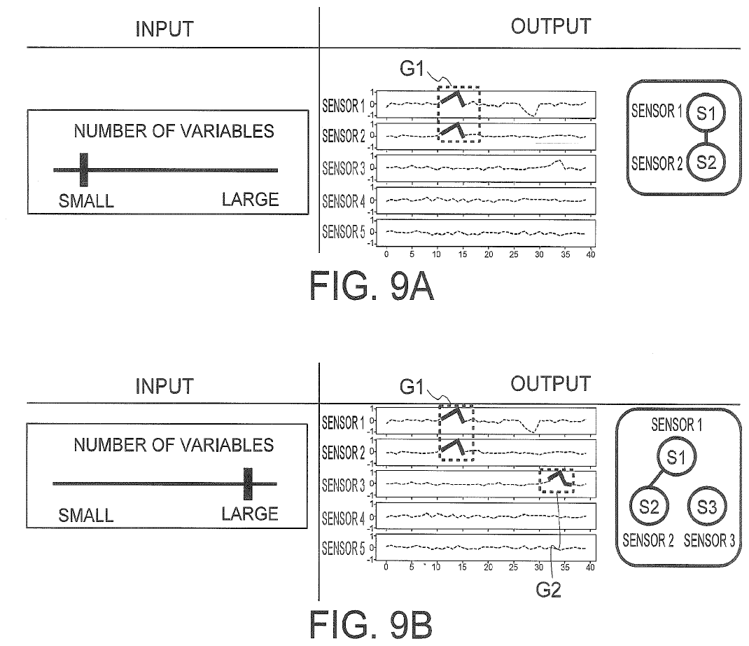

FIGS. 9A and 9B are diagrams illustrating input and output in the case of narrowing down the number of shapelets. In examples of FIGS. 9A and 9B, it is assumed that specification of the number of variables, that is, the specification of the number of time-series data is received, and the number of time-series data having corresponding shapelets is made the specified number. In FIG. 9A, input that decreases the number of variables is performed. The input is received before learning of the classification device or the like, and the updater 105 determines the number of elements that make the value of the parameter a specified value in response to the input, and narrows down the number of shapelets to be generated.

FIG. 9A illustrates that the corresponding shapelets are generated to only the time-series data of the sensors 1 and 2, in output. On the other hand, in FIG. 9B, input that increases the number of variables more than that in the example of FIG. 9A is performed. Therefore, the example in FIG. 9B also illustrates the shapelet corresponding to the time-series data by the sensor 3, which is not illustrated in the example of FIG. 9A. In this way, the time-series data having the corresponding shapelets may be narrowed down in response to a request. For example, when management is desired to be facilitated by decreasing the number of variables even if the classification performance is decreased to some degree, or conversely, when the classification performance is desired to be improved even a little even if variables are increased and management becomes difficult, the variables are specified in this way. Thereby, it is possible to generate shapelets and classification devices suitable for business needs.

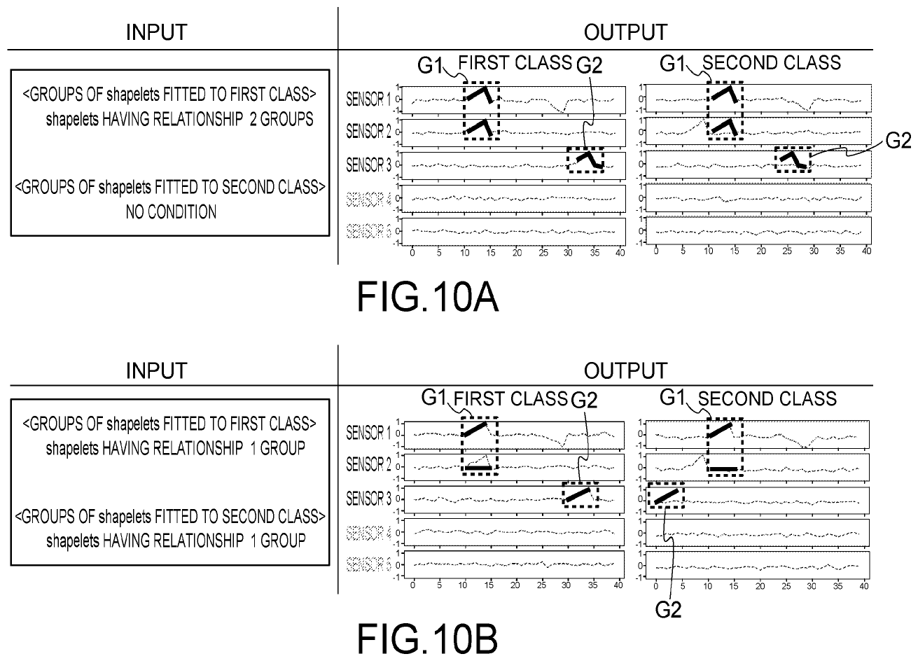

Further, specification of a class is received, and update may be performed to fit the shapelet to a waveform of time-series data that expresses the specified class. FIGS. 10A and 10B are diagrams illustrating examples of fitting the shapes of the shapelets to the specified classes. In an example in FIG. 10A, two groups of shapelets are input to be fitted to time-series data of the first class, and as output, frames G1 and G2 showing the groups fitted to the time-series data of the first class are illustrated. The shapelets in the frames G1 and G2 are fitted to the time-series data of the first class, and therefore do not match the time-series data of the second class.

On the other hand, in the example of FIG. 10B, the groups of the shapelets are input to be fitted to the time-series data of the first class and the time-series data of the second class one by one, the shapelets in the frame G1 are fitted to the time-series data of the second class, and the shapelet in the frame G2 is fitted to the time-series data of the first class. In this way, the class to which the shapes of the shapelets are fitted may be specified so that the user can easily see the output, as an option. For example, when an abnormality of equipment is desired to be detected based on the time-series data, the shapelets are matched to the time-series data indicating the abnormality, and it may be made possible to determine at a glance that the equipment is abnormal.

Note that when the number of shapelets to be matched is specified as in FIGS. 10A and 10B, the updater 105 may detect, in updating the shapelets, only the specified number of shapelets with the minimum feature value, that is, shapelets that match the waveforms of the time-series data most, and may update the detected shapelets so that the shapelets are closer to the waveform of the class.

Note that at least part of the above described embodiment may be realized by a dedicated electronic circuit (that is, hardware) such as an IC (Integrated Circuit) on which a processor, a memory and the like are packaged. Further, at least part of the above described embodiment may be realized by executing software (program). For example, it is possible to realize the processing of the above described embodiment by using a general-purpose computer device as basic hardware, and causing the processor such as a CPU mounted on the computer device to execute the program.

For example, it is possible to use the computer as the device of the above described embodiment by the computer reading out dedicated software stored in a computer-readable storage medium. A kind of the storage medium is not specially limited. Further, it is also possible to use the computer as the device of the above described embodiment by the computer installing dedicated software downloaded via a communication network. In this way, information processing by software is specifically implemented by using a hardware resource.

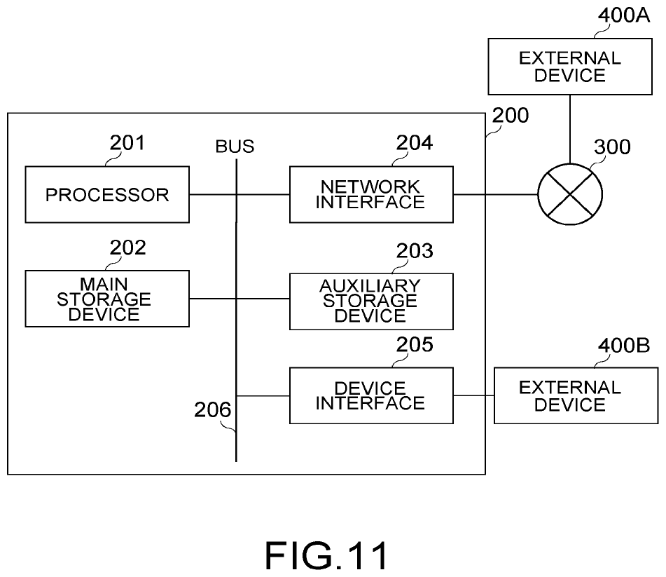

FIG. 11 is a block diagram illustrating an example of a hardware configuration in one embodiment of the present invention. An information processing apparatus 100 can be realized as a computer device 200 that includes a processor 201, a main storage device 202, an auxiliary storage device 203, a network interface 204, and a device interface 205, with these devices being connected via a bus 206. The storage 101 can be realized by the main storage device 202 or the auxiliary storage device 203, and the other components can be realized by the processor 201.

Note that the computer device 200 in FIG. 11 includes one of each of the components, but may include a plurality of the same components. Further, in FIG. 11, only one computer device 200 is illustrated, but software may be installed in a plurality of computer devices, and each of the plurality of computer devices may execute a different part of the processing of software.

The processor 201 is an electronic circuit including a control device and an arithmetic operation device of the computer. The processor 201 performs arithmetic operation processing based on data and a program input from various devices of the internal configuration of the computer device 200, and outputs arithmetic operation result and control signals to the respective devices and the like. Specifically, the processor 201 executes an OS (Operating System) of the computer device 200, applications and the like, and controls the respective devices configuring the computer device 200. The processor 201 is not specially limited as long as the processor 201 can perform the above described processing.

The main storage device 202 is a storage device configured to store commands executed by the processor 201, various data and the like, and information stored in the main storage device 202 is directly read out by the processor 201. The auxiliary storage device 203 is a storage device other than the main storage device 202. Note that these storage devices are assumed to mean arbitrary electronic components capable of storing electronic information, and may be memories or storages. Further, as memories, there are a volatile memory and a nonvolatile memory, and either one may be used.

The network interface 204 is an interface for connecting to the communication network 300 wirelessly or by wire. As the network interface 204, a network interface conforming to existing communication standards can be used. By the network interface 204, exchange of information may be performed with an external device 400A communicably connected via the communication network 300.

The device interface 205 is an interface such as a USB that directly connects to an external device 400B. The external device 400B may be an external storage medium, or a storage device such as a database.

The external devices 400A and 400B may be output devices. The output device may be, for example, a display device for displaying images, or may be a device or the like configured to output sound or the like. For example, an LCD (Liquid Crystal Display), a CRT (Cathode Ray Tube), a PDP (Plasma Display Panel), a speaker and the like are cited, but the output device is not limited to these devices.

Note that the external devices 400A and 400B may be input devices. The input device includes devices such as a keyboard, mouse, and touch panel, and gives information input by these devices to the computer device 200. Signals from the input devices are output to the processor 201.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing apparatus, comprising:
a feature value calculator configured to calculate feature values of waveforms of a plurality of time-series data for each of a plurality of reference waveform patterns;
a classifier configured to acquire a classification result by inputting the feature values to a classification device;
an updater configured to update a shape of each of the reference waveform patterns, and a plurality of parameters of the classification device; and
a detector configured to detect reference waveform patterns having a relationship, from the plurality of reference waveform patterns, based on the parameters of the classification device.

2. The information processing apparatus according to claim 1,
wherein the feature value calculator calculates the feature values based on the waveforms of the plurality of time-series data, and the plurality of reference waveform patterns.

3. The information processing apparatus according to claim 1,
wherein (i) the shape of each of the reference waveform patterns and (ii) values of the plurality of parameters of the classification device are updated, based on: a correct answer of classification based on the plurality of time-series data; and the classification result.

4. The information processing apparatus according to claim 1,
wherein respective times at which parts corresponding to the reference waveform patterns having the relationship, of time-series data corresponding to the reference waveform patterns having the relationship occur substantially match each other.

5. The information processing apparatus according to claim 1,
wherein each of the parameters of the classification device is expressed based on a weight vector including a plurality of elements,
each of the elements of the weight vector corresponds to each of the plurality of reference waveform patterns,
the updater sets at least one of the plurality of elements of the weight vector at a specific value, and
the detector detects reference waveform patterns having a relationship based on elements that are not set at the specific value, of the weight vector.

6. The information processing apparatus according to claim 5,
wherein the plurality of reference waveform patterns are classified into one or more groups,
the reference waveform patterns belonging to the groups correspond to the plurality of time-series data respectively,
the feature values are input into the classification device by being combined into each of the groups, and
the detector detects reference waveform patterns that belong to a same group, with corresponding elements of the weight vector not set at the specific value, as the reference waveform patterns having a relationship.

7. The information processing apparatus according to claim 6,
wherein the feature value is a Euclidean distance of the time-series data and the reference waveform pattern, and
positions of offsets, which are for calculating the Euclidean distance, of the respective reference waveform patterns belonging to the same group match each other.

8. The information processing apparatus according to claim 6,
wherein the feature value is a Euclidean distance of the time-series data and the reference waveform pattern, and
a difference between positions of offsets, which are for calculating the Euclidean distance, of the respective reference waveform patterns belonging to the same group is within a predetermined range.

9. The information processing apparatus according to claim 5, further comprising
an input device configured to receive specification of a number of reference waveform patterns,
wherein the updater updates the weight vector so that a number of elements that is not set at the specific value matches the specified number.

10. The information processing apparatus according to claim 5, further comprising
an input device configured to receive specification of a number of reference waveform patterns, and specification of a classification item,
wherein the updater performs update so that shapes of a same number of reference waveform patterns as the specified number become closer to a part of a waveform of time-series data corresponding to the specified classification item.

11. The information processing apparatus according to claim 6, further comprising
an input device configured to receive specification of a classification item,
wherein the updater performs update so that shapes of the respective reference waveform patterns belonging to the group become closer to a part of a waveform of time-series data corresponding to the specified classification item.

12. The information processing apparatus according to claim 5,
wherein the updater updates values of the elements of the weight vector by using a gradient descent method.

13. The information processing apparatus according to claim 5,
wherein the element of the weight vector to be set at the specific value is determined by using sparse modeling.

14. The information processing apparatus according to claim 1, further comprising
an output device configured to output at least information indicating the reference waveform patterns having the relationship.

15. An information processing apparatus different from the information processing apparatus according to claim 1,
wherein a classification result to a plurality of time-series data a correct answer of classification of which is unknown is acquired by using a classification device having values of parameters updated by the information processing apparatus according to claim 1.

16. An information processing method, comprising:
calculating feature values of waveforms of a plurality of time-series data for each of a plurality of reference waveform patterns;
acquiring a classification result by inputting the feature values into a classification device;
updating shapes of the respective reference waveform patterns, and a plurality of parameters of the classification device; and
detecting reference waveform patterns having a relationship from the plurality of reference waveform patterns, based on the parameters of the classification device.

17. A non-transitory computer readable medium storing a program executed by a computer, comprising:
calculating feature values of waveforms of a plurality of time-series data for each of a plurality of reference waveform patterns;
acquiring a classification result by inputting the feature values into a classification device;
updating shapes of the respective reference waveform patterns, and a plurality of parameters of the classification device; and
detecting reference waveform patterns having a relationship from the plurality of reference waveform patterns, based on the parameters of the classification device.
